(19) United States
(12) Patent Application Publication
(10) Pub. No.: US 2025/0050789 A1
(43) Pub. Date: Feb. 13, 2025

(54) ASSEMBLY OF A VEHICLE, HAVING A GUIDE RAIL COMPRISING A CONNECTION ASSEMBLY

(71) Applicant: BROSE FAHRZEUGTEILE SE & CO. KOMMANDITGESELLSCHAFT, COBURG, Coburg (DE)

(72) Inventor: Sergej KOSTIN, Coburg (DE)

(21) Appl. No.: 18/717,915

(22) PCT Filed: Jun. 12, 2022
(86) PCT No.: PCT/EP2022/084496

§ 371 Date: Jun. 7, 2024

(30) Foreign Application Priority Data
Dec. 9, 2021 (DE) 10 2021 214 079.3

(51) Int. Cl. B60N 2/07; B60N 2/005; F16B 5/02

(52) U.S. Cl. CPC B60N 2/07; B60N 2/005; F16B 5/02

(57) ABSTRACT

It is provided an assembly of a vehicle comprises a floor assembly which is arranged in a stationary manner in the vehicle and which comprises at least one connection opening, and an adjusting device for longitudinal adjustment of an interior assembly which comprises a guide rail which is to be connected to the floor assembly and extends along a longitudinal direction, and an adjusting assembly which is guided on the guide rail, along the longitudinal direction, and is associated with the interior assembly. The guide rail comprises at least one connection assembly for connection to the floor assembly. The at least one connection assembly comprises a hollow bolt which is arranged on the guide rail, and a screw element which is rotatable relative to the hollow pin bolt.

### BACKGROUND

The proposed solution relates to an assembly of a vehicle.

An assembly of this kind comprises a floor assembly which is arranged in a stationary manner in the vehicle, and an adjusting device for longitudinal adjustment of an interior assembly which comprises a guide rail which is to be connected to the floor assembly and extends along a longitudinal direction, and an adjusting assembly which is guided on the guide rail, along the longitudinal direction, and is associated with the interior assembly. The guide rail comprises at least one connection assembly for connection to the floor assembly. The guide rail can be fixed to the floor assembly via the connection assembly.

An interior assembly of this kind can in particular be a vehicle seat in a vehicle. An interior assembly of this kind can, however, also be another assembly in the interior of a vehicle, for example a console element, which is intended to be adjustable in the vehicle interior.

In a conventional vehicle, a vehicle seat can be adjusted relative to a vehicle floor using a longitudinal adjustment device, as is known for example from DE 10 2015 215 592 A1. In this case, guide rails extend in parallel with one another on both sides of the vehicle seat, in order to shift the vehicle seat forwards or backwards in the vehicle, and in this way set a comfortable position for a vehicle occupant.

Conventional guide rails are comparatively short, for example shorter than 50 cm, in order to be able to adjust a vehicle seat between a front position and a rear position. For connection of comparatively short guide rails of this kind to a floor assembly, conventionally drilled holes are made in a base of the respective guide rail, in order to screw the respective guide rail to the floor assembly through the drilled holes, and thus mount it in the vehicle.

In connection with new vehicle technologies, in particular in connection with autonomous driving, it may be desirable to design an adjustment range for a vehicle seat or another interior assembly to be significantly larger, in order to be able to shift the interior assembly far towards the rear in a vehicle, for example. For this purpose, it is envisaged to use significantly longer guide rails, in particular of a length of more than 50 cm, which are in turn to be rigidly connected to a floor assembly of the vehicle.

For reasons of strength and rigidity, a long guide rail is not only to be connected at its ends to the floor assembly, but rather must also be connected sufficiently strongly to the floor assembly between the ends. In the case of a longitudinal adjustment device, a spindle extending along the longitudinal direction is typically arranged on the guide rail, on which an adjusting transmission associated with the adjusting assembly is adjustably arranged, such that the adjusting assembly can be moved relative to the guide rail by driving the adjusting transmission. While typically fastening to the floor assembly via fastening elements in the form of screws is possible at ends of the guide rail, screws of this kind cannot be readily arranged on such regions of the guide rail on which the spindle extends, because a screw tool cannot readily access the screw heads without being impeded by the spindle. Since damage to the spindle during mounting must absolutely be avoided, other fastening means are therefore required for fastening the guide rail, in particular in an internal region between ends of the guide rail.

In the case of an assembly of a vehicle known from DE 10 2018 210 033 A1, a guide rail comprises of a longitudinal adjusting means of the vehicle seat comprises at least one connection element which comprises an engagement portion for form-fitting engagement in an engagement means arranged on a floor assembly, on a first side of the guide rail, and a connection portion having a fastening point for fixing the connection element on the floor assembly using a fastening element on a second side of the guide rail remote from the first side.

### SUMMARY

The object underlying the proposed solution is that of providing an assembly of a vehicle and a method for mounting an adjusting device, which allow for simple, cost-effective mounting of the guide rail in a vehicle.

This object is achieved by a connection assembly having the features as described herein.

According thereto, the at least one connection assembly comprises a hollow bolt which is arranged on the guide rail, and a screw element which is rotatable relative to the hollow bolt. The hollow bolt, together with the screw element arranged thereon, can be inserted into the at least one connection opening of the floor assembly, and can be fixed to the floor assembly by twisting the screw element on the hollow bolt.

For mounting the guide rail on the floor assembly, the guide rail is fixed on the floor assembly. Upon fixing, one or more connection assemblies arranged on the guide rail are inserted into associated connection openings of the floor assembly, wherein for this purpose in each case a hollow bolt, having a screw element arranged thereon, of each connection assembly, is introduced into a connection opening that is associated in each case. Thereupon, by twisting the screw element on the hollow bolt, the guide rail can be fixed to the floor assembly, in that a clamping effect is brought about between the guide rail and the floor assembly via the screw element, for example.

The floor assembly can be a vehicle floor that is visible from the vehicle interior. The floor assembly can, however, for example also be a supporting vehicle structure under the visible vehicle floor, for example a sill structure in the region of an entry point, or a tunnel structure in the center of the vehicle, or another portion of the vehicle body.

The guide rail comprises, for example, a base and a limb which extends on the base. The guide rail can thus have a U-shaped basic shape (viewed in cross-section transversely to the longitudinal direction). Between the limbs the adjusting assembly, in particular an adjusting rail of the adjusting assembly, is guided along the longitudinal direction, such that the adjusting assembly can be displaced longitudinally on the guide rail.

In this case, the connection assembly is preferably arranged on the base. The base can be fixed on the floor assembly in order to connect the guide rail to the floor assembly. While the limbs extend on a first side of the base and the adjusting assembly is guided between the limbs on the first side of the guide rail, the at least one connection assembly preferably protrudes from the base on a second side of the guide rail remote from the first side, such that, when the guide rail is fixed to the floor assembly, the at least one connection assembly comprising the associated connection opening comes into engagement on the floor assembly and can be fixed to the floor assembly by screwing the screw element.

The screw element is preferably in threaded engagement with an external thread of the hollow bolt via an internal thread formed on the screw element. Twisting the screw element on the hollow bolt thus also adjusts the screw element axially on the hollow bolt, such that in this way fixing of the guide rail to the floor assembly can be established.

The internal thread of the screw element and/or the external thread of the hollow bolt can for example be implemented via trilobular thread or a thread having an invisible thread, in order to in this way create rotational locking between the screw element and the hollow bolt. In particular, upon delivery of the guide rail the screw element should be located in a position on the hollow bolt that is such that the guide rail can be mounted on the floor assembly by a vehicle manufacturer directly. i.e. without adjustment of the position of the screw element. During transport, the position of the screw element on the hollow bolt can be secured in threaded engagement by rotational locking.

In one embodiment, the hollow bolt comprises a bolt opening into which a tool can be inserted and via which the tool can be brought into operative connection with the screw element for twisting the screw element. The tool can thus be guided through the hollow bolt. The tool can thus be brought into operative connection with the screw element on the hollow bolt, such that twisting the tool makes it possible for the screw element on the hollow bolt to be twisted, and thus for the connection assembly to be fixed on the floor assembly.

The tool can thus be designed as a tool which engages internally in the hollow bolt or the screw element. For this purpose, the tool can in particular be polygonal in shape, having an external polygon for establishing an operative connection to the screw element. The tool can thus be of small dimensions, in cross-section transversely to an insertion direction, such that the tool can be introduced into the hollow bolt and thereby brought into operative connection with the screw element, without this being impeded by a spindle arranged on the guide rail, and without any notable risk of damage to the spindle by the tool.

In one embodiment, the guide rail comprises an opening, preferably on the base that carries the connection assembly, which opening is flush with the bolt opening and through which the tool can be inserted into the bolt opening of the hollow bolt. The hollow bolt can for example be inserted by a portion into the opening, such that the hollow bolt can be fixed to the guide rail, for example welded, by engagement of the hollow bolt in the opening. While the hollow bolt extends, for engagement, into the floor assembly on a side remote from the interior of the guide rail, the tool can be introduced from the first side of the guide rail, through the opening of the guide rail, into the hollow bolt on the second side of the guide rail, and thereby brought into operative connection with the screw element, in order, in this way, to twist the screw element when a connection assembly is inserted into the connection opening of the floor assembly. Simple mounting results, in which the fixing of the guide rail to the floor assembly can be established in a simple manner, in the vehicle interior, by twisting the screw element of the connection assembly.

In one embodiment, the adjusting device comprises a spindle which is rigidly connected to the guide rail and extends along the longitudinal direction. For example an adjusting transmission associated with the adjusting assembly is operatively connected to the spindle, for example in that a spindle nut of the adjusting transmission is in threaded engagement with the spindle, such that the adjusting transmission, and thus the adjusting assembly, can be adjusted relative to the spindle, longitudinally along the longitudinal direction, by electromotive driving of the spindle nut. The tool can be insertable into the bolt opening of the hollow bolt for example along a vertical direction that is perpendicular to the longitudinal direction. In this case, the spindle is preferably spaced apart from the bolt opening along a transverse direction oriented transversely to the longitudinal direction and transversely to the vertical direction. The spindle is thus not in the way along an insertion direction of the tool facing along the longitudinal direction, but rather is spaced apart transversely to an insertion direction of the tool, such that the tool, when engaging in the bolt opening of the hollow bolt, does not collide with the spindle, and thus the risk of damage to the spindle when establishing the connection is at least reduced.

In one embodiment, the screw element comprises a tool engagement for establishing the operative connection to the tool. The tool engagement can be formed for example by a polygonal opening on the screw element, into which the tool can be inserted, in order in this way to establish a torque-resistant, form-fitting connection between the tool and the screw element, and to transfer a torque from the tool to the screw element. Thus, the screw element on the hollow bolt can be twisted by twisting the tool, in order to in this way fix the connection assembly to the floor assembly (or vice versa to release the connection assembly for dismantling the guide rail).

In one embodiment, the hollow bolt is welded to the guide rail. In another embodiment, the hollow bolt can for example be screwed or riveted to the guide rail. The hollow bolt is fixedly arranged on the guide rail and protrudes from the guide rail at a side facing the floor assembly. When fixing the guide rail to the floor assembly, the hollow bolt, comprising the screw element arranged thereon, is brought into engagement with the associated connection opening of the floor assembly, such that a connection between the guide rail and the floor assembly can be established by twisting the screw element.

In particular, the floor assembly, in the inserted position of the at least one connection assembly, can be able to be clamped between the screw element and the guide rail. Twisting the screw element on the hollow bolt thus establishes a clamped connection between the guide rail and the floor assembly, wherein a portion of the floor assembly is clamped between the screw element and the portion of the guide rail carrying the hollow bolt, for example the base of the guide rail, such that in this way the guide rail is fixed to the floor assembly.

In one embodiment, the at least one connection opening of the floor assembly comprises a first opening portion, into which the hollow bolt, having the screw element arranged thereon, can be inserted in an insertion direction, and a second opening portion, which adjoins the first opening portion and into which the hollow bolt is movable, after insertion, out of the opening portion transversely to the insertion direction. The first opening portion is shaped in such a way that the screw element can be guided through the first opening portion. The first opening portion thus has a clear width which is such that the connection assembly can be brought into engagement with the floor assembly via the first opening portion and, in the inserted position, the screw element comes to rest on a side remote from the guide rail of a portion of the floor assembly bearing the connection opening. After insertion into the first opening portion, the connection assembly (together with the guide rail) can then be displaced relative to the floor assembly, transversely to the insertion direction, such that as a result the connection assembly is inserted into the region of the second opening portion of the connection opening.

The second opening portion in particular has a clear width which is such that the second opening portion can receive the hollow bolt of the connection assembly. In this case, the clear width of the second opening portion is preferably reduced relative to the clear width of the first opening portion, such that in a position in which the hollow bolt is introduced into the second opening portion, a clamped connection between the guide rail and the floor assembly can be established by twisting the screw element.

A mounting sequence results in which firstly the guide rail is fixed on the floor assembly in the insertion direction, and as a result each connection assembly is introduced into the associated connection opening on the floor assembly. In this case, the connection assembly is introduced in that the connection assembly is inserted into the first opening portion of the connection opening. After insertion, the guide rail comprising the connection assembly arranged thereon can be displaced on the floor assembly, transversely to the insertion direction, such that as a result the connection assembly together with the hollow bolt enters the region of the second opening portion. After insertion into the second opening portion, it is possible to twist the screw element on the hollow bolt, in order to in this way establish a clamped connection between the guide rail and the floor assembly.

The screw element is arranged on the hollow bolt and has a radial diameter which is larger than the diameter of the hollow bolt. Preferably, in this case, in a position in which the hollow bolt is arranged in the second opening portion of the connection opening, the screw element overlaps an edge portion defining the second opening portion, such that twisting the screw element on the hollow bolt makes it possible for the screw element to be clamped with the edge portion, and thus a clamped connection between the guide rail and the floor assembly can be established.

The object is also achieved by a method for mounting an adjusting device for longitudinal adjustment of an interior assembly in a vehicle. The method comprises: Connecting a guide rail, extending along a longitudinal direction and intended for guiding an adjusting assembly associated with the interior assembly, to a floor assembly arranged in a stationary manner in the vehicle, wherein for the purpose of connecting, at least one connection assembly, which comprises a hollow bolt arranged on the guide rail and a screw element which is rotatable relative to the hollow bolt, is inserted into at least one connection opening of the floor assembly and is fixed to the floor assembly by twisting the screw element on the hollow bolt.

The advantages and advantageous embodiments described above for the assembly also apply analogously for the method, and therefore reference is made to what has been stated above.

### BRIEF DESCRIPTION OF THE DRAWINGS

The concept underlying the solution will be explained in greater detail in the following, with reference to the embodiments shown in the drawings.

FIG. 1 is a schematic view of an interior assembly in the form of a vehicle seat, which is longitudinally adjustable via an adjusting device;

FIG. 2 is a schematic view of the adjusting device, comprising two pairs of guide rail for longitudinal adjustment of the vehicle assembly.

FIG. 3 is a view of an adjusting assembly on an associated guide rail.

FIG. 4 is a view of the guide rail together with a floor assembly.

FIG. 5 is a side view of the arrangement according to FIG. 4.

FIG. 6 is an enlarged view of a connection assembly of the guide rail in the region of a connection opening of the floor assembly.

FIG. 7A is a view of the connection assembly upon insertion into the connection opening along an insertion direction.

FIG. 7B is a side view of the arrangement according to FIG. 7A.

FIG. 8A is a view of the connection assembly upon transverse displacement in the connection opening.

FIG. 8B is a side view of the arrangement according to FIG. 8A.

FIG. 9A is a view of the connection assembly in the connection opening, in a clamped position.

FIG. 9B is a side view of the arrangement according to FIG. 9A.

FIG. 10A is the view according to FIG. 8B.

FIG. 10B is a sectional view along the line A-A according to FIG. 10A.

FIG. 10C is the side view according to FIG. 10B, having a tool inserted into a bolt opening of a hollow bolt of the connection assembly.

### DETAILED DESCRIPTION

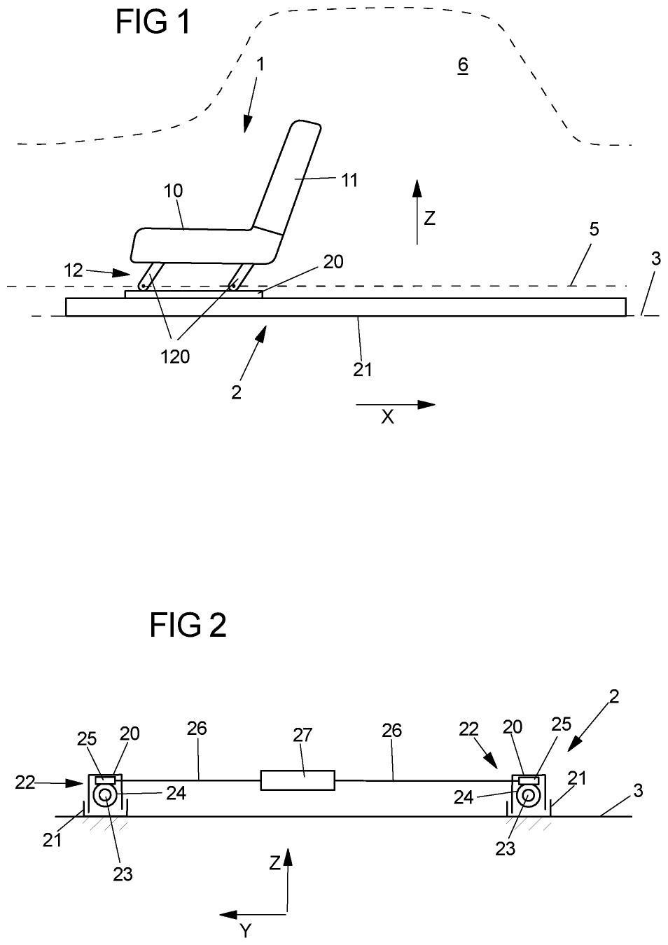

FIG. 1 is a schematic view of an interior assembly in the form of a vehicle seat 1, which comprises a seat part 10 and a backrest part 11 which can be adjusted in its inclination on the seat part 10.

The interior assembly in the form of the vehicle seat 1 is connected via a height-adjustment device 12 to an adjusting device 2 for longitudinal adjustment of the vehicle seat 1 along a longitudinal direction X. For this purpose, the vehicle seat 1 is connected to two pairs of guide rails, via kinematics parts 120 in the form of what are known as motion links of the height-adjustment device 12, and thereby mounted so as to be displaceable along the longitudinal direction X.

As can be seen from the schematic view according to FIG. 2, in the embodiment shown the adjusting device 2 comprises two guide rail pairs, which are each formed by an upper adjustment rail 20 and a lower guide rail 21. The adjustment rail 20, which forms an adjusting assembly, is coupled to the vehicle seat 1 via the height-adjustment device 12 in such a way that the vehicle seat 1 can be moved along the longitudinal direction X by longitudinal adjustment of the adjustment rail 20. The lower guide rails 21 are fixed on a floor assembly 3, such that the vehicle seat 1 is displaceable relative to the floor assembly 3 via the lower guide rails 21.

As can be seen from FIG. 1, the guide rail 21 can in particular be arranged under a vehicle floor 5 which is visible from the vehicle interior, and for example is covered by a carpet. In this case, the floor assembly 3 is formed for example by a support structure arranged below the visible vehicle floor 5, for example a sill or tunnel structure of the vehicle.

Each guide rail pair is, in the embodiment shown in FIG. 2, associated with an adjusting transmission 22, which comprises a spindle nut 24 arranged on a spindle 23, which nut is in threaded engagement with the spindle 23 and rolls on the spindle 23, upon twisting, in such a way that the spindle nut 24 is moved longitudinally along the longitudinal direction X, relative to the spindle 23. A drive element 25, for example in the form of a driving worm, is in interlocking engagement with the spindle nut 24, such that an adjustment force can be introduced into each spindle nut 24, via an associated drive shaft 26 and a drive motor 27, and thus the adjusting transmission 22 of the guide rail pairs can be driven.

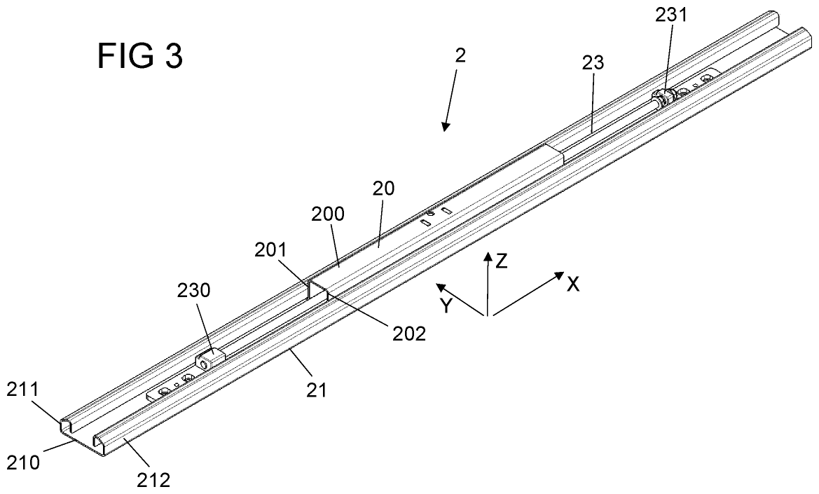

An embodiment of a guide rail pair is shown in FIG. 3. In the embodiment shown, the lower guide rail 21 is comparatively long, for example longer than 1 m, for example longer than 1.5 m, in order to allow for adjustment of the interior assembly, in the form of the vehicle seat 1, over an adjustment region of a comparative size in a vehicle interior. The adjusting rail 20 is guided longitudinally along the longitudinal direction X, on the guide rail 21, wherein for this purpose rail limbs 201, 202 of the adjusting rail 20, arranged on a base 200, are received between limbs 211, 212 of the guide rail 21 that are arranged on a base 210.

In the embodiment shown, a spindle 23 is fixed on the base 210 of the guide rail 21 in a non-rotatable manner, by means of fastening elements 230, 231 in the form of what are known as spindle retaining brackets. An adjusting transmission 22 (see FIG. 2) associated with the adjusting rail 20 is operatively connected to the stationary spindle 23 in such a way that the adjusting rail 20 can be moved longitudinally along the longitudinal direction X, relative to the guide rail 21, by driving the adjusting transmission 22.

For the purpose of mounting, the guide rail 21 is to be fixed on the floor assembly 3. Owing to the length of the guide rail 21, in this case fastening merely at the ends of the guide rail 21, at which the spindle 23 does not extend, may not be sufficient, and therefore further measures for fixing the guide rail 21 to the floor assembly 3, also in an internal region between the ends of the guide rail 21, are required.

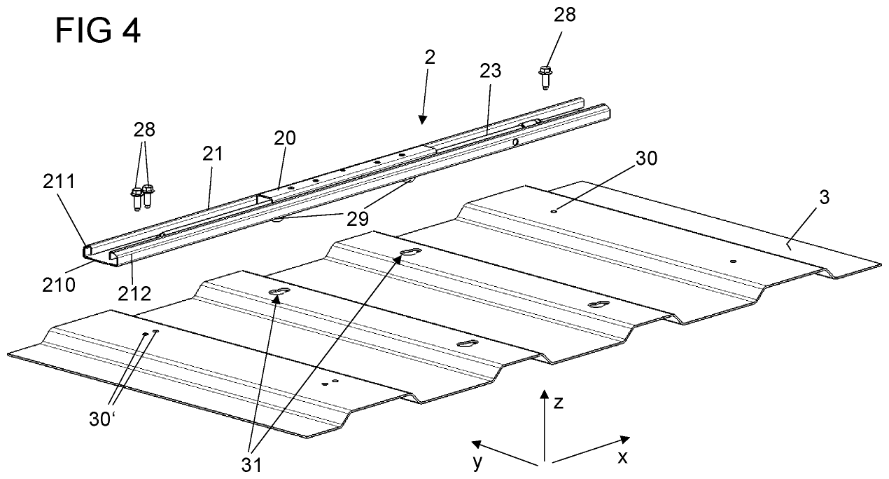

In an embodiment shown in FIG. 4, ends of the guide rail 21 are in each case to be screwed to fastening openings 30 of the floor assembly 3 by means of fastening elements 28 in the form of screws. The ends of the guide rail 21, in which the spindle 23 does not extend, are thus connected (as is conventional) to the floor assembly 3 by means of screws 28.

Furthermore, the guide rail 21 comprises connection assemblies 29 which are arranged in an internal region between the ends of the guide rail 21 and protrude from the base 210 in the direction of the floor assembly 3. The connection assemblies 29 can be brought into engagement with associated connection openings 31 on the floor assembly 3. Via the connection assemblies 29 a connection (additional to the fastening elements 28) can be established in particular in a region of the guide rail 21 in which the spindle 23 extends. In this case, the connection assemblies 29 are designed such that fixing of the guide rail 21 via the connection assemblies 29 is possible using a tool by means of which it is possible to access the connection assemblies 29 from the interior side of the guide rail 21, without there being any risk of a collision with the spindle 23 in the process, and thus a risk of damage to the spindle 23 during mounting is at least reduced.

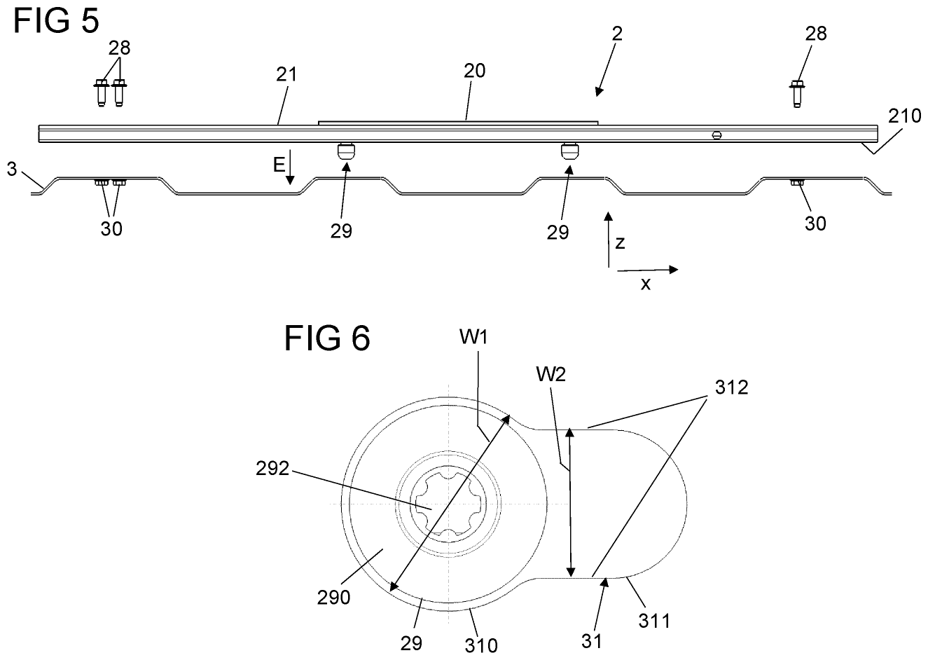

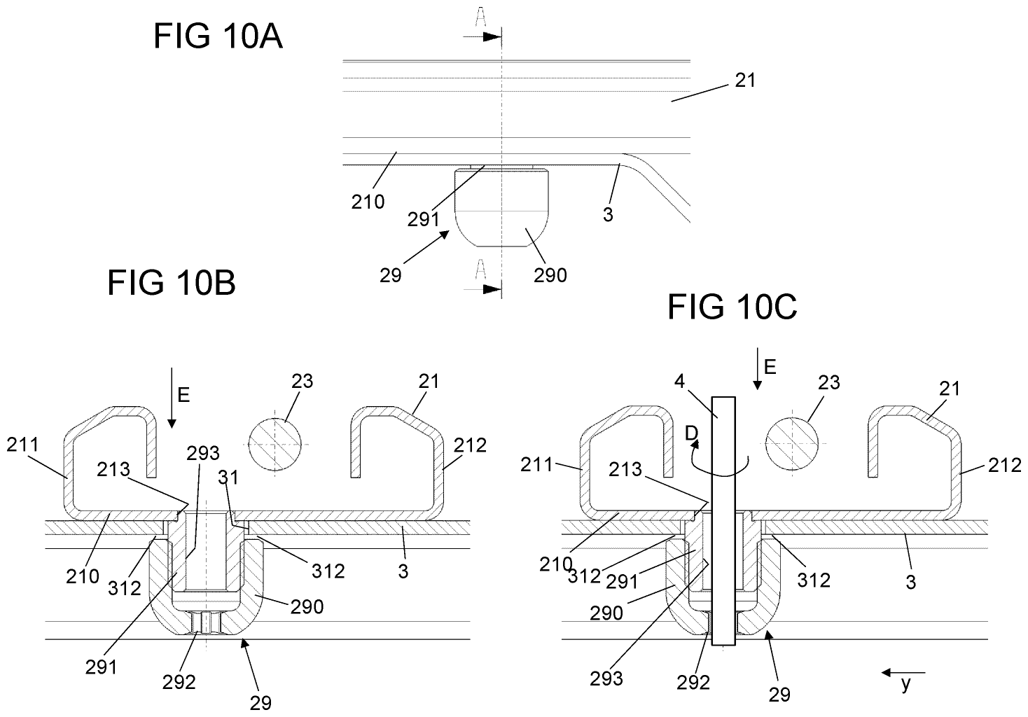

As can be seen from FIGS. 5 and 6 in overview with the sectional views according to FIGS. 10A to 10C, each connection assembly 29 comprises a hollow bolt 291, which is inserted with a flange portion into an associated opening 213 on the base 210 of the guide rail 21 and is rigidly connected to the base 110, for example welded. A screw element 290 in the form of what is known as a cup nut is arranged on the hollow bolt 291, which nut is in threaded engagement with the hollow bolt 291 in such a way that the screw element 290 can be screwed to the hollow bolt 291. For this purpose, an external thread formed on the outside of the hollow bolt 291 is in threaded engagement with an internal thread formed on the inside of the screw element 290, such that the screw element 290 can be twisted relative to the hollow bolt 291 in a screwing manner.

While the limbs 211, 212 are arranged on a first side of the base 210 of the guide rail 21, and the connection assemblies 29 protrude from the base 210 on a second side (at the bottom in FIG. 5) facing away from the first side. Upon fixing of the guide rail 21 to the floor assembly 3, the connection assemblies 29 can be introduced into the connection openings 31 in order to in this way create a connection between the base 210 of the guide rail 21 in the internal region between the ends of the guide rail 21 and the floor assembly 3.

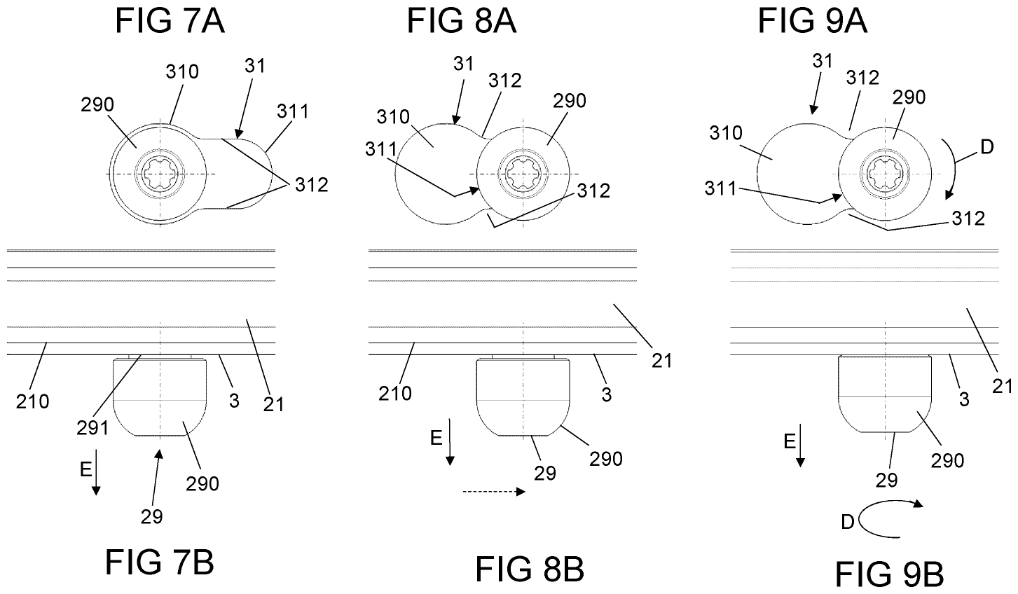

As can be seen from FIG. 6 in overview with FIGS. 7A, 7B to 9A, 9B, each connection opening 31 on the floor assembly 3 comprises two opening portions 310, 311.

A first opening portion 310 has a clear width W1 which is larger than the outside diameter of the screw element 290. The opening portion 310 has a circular basic shape, and thus allows insertion of the associated connection assembly 29, comprising the screw element 290 arranged on the hollow bolt 291, in an insertion direction E.

A second opening portion 311 adjoins the first opening portion 310, which second opening portion has a reduced clear width W2 compared with the clear width W1 of the first opening portion 310. The clear width W2 of the second opening portion 311 is larger than the outside diameter of the hollow bolt 291, such that the hollow bolt 291 can be introduced into the second opening portion 311 by transverse displacement transversely to the insertion direction E, as can be seen in the transition from FIGS. 7A, 7B to FIGS. 8A, 8B. In this case, however, the clear width W2 of the second opening portion 311 is smaller than the outside diameter of the screw element 290, such that the screw element 290 overlaps with edge portions 312 which define the second opening portion 311, when the hollow bolt 291 has been introduced into the second opening portion 311.

If the hollow bolt 291 has been introduced into the second opening portion 311, as is shown in FIGS. 8A, 8B, then the screw element 290 can be twisted, on the hollow bolt 291, in a screw direction D, in order to in this way, as shown in FIGS. 9A, 9B, establish a clamped connection of the floor assembly 3 to the base 210 of the guide rail 21.

In this case, the screw element 290 overlaps with the edge portions 312 defining the second opening portion 311. In the clamped position, the portion of the floor assembly 3 bearing the connection opening 31 thus assumes an intermediate position between the screw element 290 and the base 210 of the guide rail 21, wherein the floor assembly 3 is clamped to the base 210 via the screw element 290, as can be seen in FIGS. 9A, 9B.

A mounting sequence results in which the guide rail 21 is first fixed on the floor assembly 3 in the insertion direction E that extends in parallel with the vertical direction Z, as can be seen from FIG. 5. In this case, the connection assemblies 29 are inserted into the associated connection openings 31, in that the screw elements 290 of the connection assemblies 29 are guided through the first opening portions 310 of the connection openings 31, as can be seen in FIGS. 7A, 7B.

The guide rail 21 is then displaced as a whole transversely to the insertion direction E, on the floor assembly 3, such that the hollow bolts 291 of the connection assemblies 29 are in each case introduced into the second opening portion 311 of the associated connection opening 31, as can be seen in FIGS. 8A, 8B.

Subsequently, the screw elements 290 are screwed to the hollow bolts 291, in order to in this way establish a clamped connection between the floor assembly 3 and the guide rail 21, and thus to fix the guide rail 21 on the floor assembly 3.

In addition, the fastening elements 28 in the form of the screw at the ends of the guide rail 21 are screwed into the associated fastening openings 30 on the floor assembly 3, in order to also fix the guide rail 21 at its ends.

As can be seen from FIGS. 10B and 10C, each hollow bolt 291 of the connection assemblies 29 comprises a bolt opening 293 which extends axially along the insertion direction E and which is flush with the associated opening 213 on the base 210 of the guide rail 21. In addition, a tool engagement 292 in the form of a polygonal opening, which is flush with the bolt opening 293, is formed on the screw element 290. Thus, a tool 4 can be brought into operative connection with the tool engagement 292 on the screw element 290 through the bolt opening 293, such that it is possible to twist the screw element 290 on the hollow bolt 291 by twisting the tool 4 along the screw direction D.

In this case, the tool 4 can be introduced into the hollow bolt 291 proceeding from the first side of the guide rail 21 on which the limbs 211, 212 extend. The twisting of the screw element 290 can thus take place from the interior of the guide rail 21, such that the screw element 290 can be accessed from the interior of the vehicle and can be twisted, for establishing the clamped connection, at the hollow bolt 291.

Since the tool 4 is designed as a screw tool comprising an internal drive, i.e. having an external polygon for engagement in the polygonal opening 292 of the screw element 290, the tool 4 has a small extension in cross-section transversely to the extension direction E. Since, furthermore, the spindle 23 is spaced apart from the connection assembly 29 along the transverse direction Y extending transversely to the longitudinal direction X and transversely to the vertical direction Z, when used as intended the tool 4 does not collide with the spindle 23, such that the risk of damage to the spindle 23 during mounting is at least reduced.

The fixing of the guide rail 21 on the floor assembly 3 is thus possible in a simple manner, in the sense of blind mounting, in that the tool 4 is brought into engagement with the screw element 290 of the respective connection assembly 29, in order to in this way screw the screw element 290 on the side of the floor assembly 3 remote from the guide rail 21 and thus to establish a clamped connection between the guide rail 21 and the floor assembly 3.

The concept on which the solution is based is not limited to the embodiments described above, but rather can also be implemented in another manner.

The guide rail can comprise one or more connection assemblies.

In this case, it is conceivable to provide additional fastening elements in the form of screw elements, in particular for fixing at the ends of the guide rail. Such fastening elements can possibly also be omitted, however. Fixing of the guide rail on the floor assembly can also be established merely via one or more connection assemblies.

The establishment of the connection via one or more connection assemblies of the type described allows for a direct floor connection of the guide rail, with simple mounting and favorable force flow in the mounted position, for secure and reliable support, in particular also in the event of a crash load.

### LIST OF REFERENCE SIGNS

1 interior assembly (vehicle seat)
10 seat part
11 backrest part
12 height-adjustment device
120 kinematics parts
2 longitudinal adjustment device
20 adjusting assembly (adjusting rail)
200 base
201, 202 rail limbs
21 guide rail
210 base
211, 212 limbs
213 opening
22 adjusting transmission
23 spindle
230, 231 fastening element
24 spindle nut
25 drive element (driving worm)
26 drive shaft
27 drive motor
28 fastening element
29 connection assembly
290 screw element (cap nut)
291 hollow bolt
292 tool opening
293 bolt opening
3 floor assembly
30 fastening opening
31 connection opening
310, 311 opening portion
312 edge portion
4 screw tool
5 visible vehicle floor
6 vehicle
D screw direction
E insertion direction
W1, W2 clear width
X longitudinal direction
Y transverse direction
Z vertical direction

1. An assembly of a vehicle, comprising
a floor assembly which is arranged in a stationary manner in the vehicle and which comprises at least one connection opening, and
an adjusting device for longitudinal adjustment of an interior assembly which comprises a guide rail which is to be connected to the floor assembly and extends along a longitudinal direction, and an adjusting assembly which is guided on the guide rail, along the longitudinal direction, and is associated with the interior assembly,
wherein the guide rail comprises at least one connection assembly for connection to the floor assembly,
wherein the at least one connection assembly comprises a hollow bolt which is arranged on the guide rail, and a screw element which is rotatable relative to the hollow bolt, wherein the hollow bolt comprising the screw element arranged thereon can be inserted into the at least one connection opening of the floor assembly and can be fixed to the floor assembly by twisting the screw element on the hollow bolt.

2. The assembly according to claim 1, wherein the guide rail comprises a base and limbs extending on the base, wherein the at least one connection assembly is arranged on the base.

3. The assembly according to claim 2, wherein the adjusting assembly is guided between the limbs on a first side of the guide rail and the at least one connection assembly protrudes from the base on a second side of the guide rail facing away from the first side.

4. The assembly according to claim 1, wherein the hollow bolt comprises a bolt opening into which a tool can be inserted and via which the tool can be brought into operative connection with the screw element for twisting the screw element.

5. The assembly according to claim 4, wherein the guide rail comprises an opening which is flush with the bolt opening and through which the tool can be inserted into the bolt opening of the hollow bolt.

6. The assembly according to claim 4, wherein the adjusting device comprises a spindle which is rigidly connected to the guide rail and extends along the longitudinal direction, wherein the tool can be inserted into the bolt opening of the hollow bolt along a vertical direction which is perpendicular to the longitudinal direction, and the spindle is spaced apart from the bolt opening along a transverse direction that is oriented transversely to the longitudinal direction and transversely to the vertical direction.

7. The assembly according to claim 4, wherein the screw element comprises a tool engagement for establishing the operative connection to the tool.

8. The assembly according to claim 7, wherein the tool engagement is formed by a polygonal opening on the screw element.

9. The assembly according to claim 1, wherein the hollow bolt is welded to the guide rail.

10. The assembly according to claim 1, wherein the floor assembly, in the inserted position of the at least one connection assembly, can be clamped between the screw element and the guide rail.

11. The assembly according to claim 1, wherein the at least one connection opening of the floor assembly comprises a first opening portion, into which the hollow bolt, having the screw element arranged thereon, can be inserted in an insertion direction, and a second opening portion, which adjoins the first opening portion and into which the hollow bolt is movable, after insertion, out of the first opening portion transversely to the insertion direction.

12. The assembly according to claim 11, wherein the second opening portion has a reduced clear width compared with the first opening portion.

13. The assembly according to claim 11, wherein, when the hollow bolt is arranged in the second opening portion, the screw element overlaps an edge portion defining the second opening portion, and can be clamped to the edge portion by twisting.

14. A method for mounting an adjusting device for longitudinal adjustment of an interior assembly in a vehicle, comprising:
connecting a guide rail, extending along a longitudinal direction and intended for guiding an adjusting assembly associated with the interior assembly, to a floor assembly arranged in a stationary manner in the vehicle,
wherein for the purpose of connecting, at least one connection assembly, which comprises a hollow bolt arranged on the guide rail and a screw element which is rotatable relative to the hollow bolt, is inserted into at least one connection opening of the floor assembly and is fixed to the floor assembly by twisting the screw element on the hollow bolt.
